(19) United States
(12) Patent Application Publication
(10) Pub. No.: US 2006/0045039 A1
(43) Pub. Date: Mar. 2, 2006

(54) Program, method, and device for managing system configuration

(75) Inventors: Akira Tsuneya, Kawasaki (JP); Kenji Takahashi, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/991,026

(22) Filed: Nov. 17, 2004

(30) Foreign Application Priority Data
Jun. 25, 2004 (JP) 2004-188516

(51) Int. Cl. H04B 7/185

(52) U.S. Cl. 370/318

(57) ABSTRACT

A system configuration management program that identifies what kind of resources are lacking in a managed system, based on the current operating condition of that system, and installs required resources in a timely manner. An operating condition monitor observes current load condition of a managed system that is in operation. According to the degree of increase in the system load observed in a predetermined period, a resource addition decision unit determines whether it is necessary to add hardware resources to the system, as well as what kind of hardware resources should be added, while consulting a resource addition policy dataset. If it is determined that an additional server is required, a server addition unit activates a spare server for use in the system. If it is determined that an additional storage unit is required, a storage addition unit permits the system to make access to a spare storage device.

### CROSS-REFERENCE TO RELATED APPLICATIONS

This application is based upon and claims the benefits of priority from the prior Japanese Patent Application No. 2004-188516, filed on Jun. 25, 2004, the entire contents of which are incorporated herein by reference.

### BACKGROUND OF THE INVENTION

1. Field of the Invention

The present invention relates to a computer program, method, and device for managing configuration of a system that is formed from a plurality of servers. More particularly, the present invention relates to a system configuration management program, method, and device that can install additional hardware resources automatically.

2. Description of the Related Art

A variety of network services are available today, which include, for example, web-based information services and electronic mail systems. As the number of service users grows, server systems providing such services sometimes experience a sudden increase in their processing load even during normal operations. Service providers have to cope with the increased access needs by raising the performance of their system as necessary. Typically, the process of system performance enhancement involves addition of required resources (such as server modules and storage devices) and subsequent reconfiguration of the entire system.

As the system grows in scale, it becomes more and more difficult to identify what functions are lacking and how urgent the situation is. In view of this fact, several researchers propose a technique that automatically changes the allocation of computer resources depending on the load level of each user organization (see Japanese Patent Application Publication No. 2002-24192). Some other researchers propose a distributed system in which a remote system monitors performance of a storage subsystem, and if a shortage of free space is observed, the remote system requests a relevant storage management site to install additional storage devices (see Japanese Patent Application Publication No. 2003-196135, paragraphs [0036]-[0040]).

When a system shows a performance drop, it is not always easy to determine whether the problem comes from a lack of processing power on the server's end or an insufficient capacity on the storage system's end. Adding another storage device in an attempt to expand the free space could impose an increased amount of storage management workload on an existing server. This means that the problem of increased system load may not always be solved by such a straightforward mechanism as adding a new storage device if a shortage of storage space is detected.

As can be seen from the above, one drawback of conventional approaches is that they only try to supply what appears to be lacking, without considering relationships between different kinds of resources, and thus fail to take a correct countermeasure. The result is an exhaustion of other resources that have not been enhanced, or an inefficient resource usage due to unnecessary addition of resources that is incurred by incorrect management decisions.

Another drawback is a lack of consideration of dissimilar behaviors of individual services provided. Some systems offer a plurality of services simultaneously, with separate hardware resources allocated to each service. Since those services consume their resources in different ways, the service provider faces difficulty in guaranteeing service level agreement (SLA) of each individual service. This situation leads to increasing demands for a improved configuration management system that can identify what kinds of resources are really needed and supply appropriate resources to the managed system.

### SUMMARY OF THE INVENTION

In view of the foregoing, it is an object of the present invention to provide a system configuration management program and device that can identify what kind of resources are lacking in a managed system, based on the current operating condition of that system, and install additional resources in a timely manner.

To accomplish the above object, the present invention provides a system configuration management program for adding hardware resources to a system in operation. This system configuration management program causes a computer to function as: (a) an operating condition monitor that observes load of the system in operation; (b) a resource addition decision unit that determines whether it is necessary to add hardware resources to the system, and what kind of hardware resources should be added, according to the degree of increase in the load observed in a predetermined period, with reference to a resource addition policy dataset that provides policy rules including whether to add a server or a storage unit; (c) a server addition unit that activates a spare server if the resource addition decision unit determines that an additional server is required, the spare server having thus far been connected to the system as a spare resource in a standby state; and (d) a storage addition unit that permits the system to make access to a spare storage device if the resource addition decision unit determines that an additional storage unit is required, the spare storage device having thus far been connected to the system as a spare resource that cannot be accessed from the system.

Additionally, to accomplish the above object, the present invention provides a system configuration management device for adding hardware resources to a working system. This system configuration management device comprises the following elements: (a) an operating condition monitor that observes load of the system in operation; (b) a resource addition decision unit that determines whether it is necessary to add hardware resources to the system, and what kind of hardware resources should be added, according to the degree of increase in the load observed in a predetermined period, with reference to a resource addition policy dataset that provides policy rules including whether to add a server or a storage unit; (c) a server addition unit that activates a spare server if the resource addition decision unit determines that an additional server is required, the spare server having thus far been connected to the system as a spare resource in a standby state; and (d) a storage addition unit that permits the system to make access to a spare storage device if the resource addition decision unit determines that an additional storage unit is required, the spare storage device having thus far been connected to the system as a spare resource that cannot be accessed from the system.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of the present invention.

FIG. 2 shows a system configuration according to an embodiment of the present invention.

FIG. 3 shows an example of hardware configuration of an administration server used in the present embodiment of the invention.

FIG. 4 shows processing functions of an administration server.

FIG. 5 shows an example data structure of a policy dataset.

FIG. 6 shows an example data structure of a service definition dataset.

FIG. 7 shows an example of a configuration dataset.

FIG. 8 shows an example data structure of a log.

FIG. 9 is a flowchart of a process of allocating additional resources, which is executed by the administration server.

FIG. 10 shows an example of an updated configuration dataset.

FIG. 11 shows an example data structure of CPU load-based server addition policy.

FIG. 12 shows an example data structure of server addition policy based on the number of accesses handled by a load balancer.

FIG. 13 shows the relationship between the access count increase of service A and access count increase threshold.

FIG. 14 shows an example data structure of a service flag dataset.

FIG. 15 shows an example data structure of a storage addition policy dataset.

FIG. 16 is a flowchart of a resource addition process based on the actual number of service requests distributed from a load balancer.

### DESCRIPTION OF THE PREFERRED EMBODIMENTS

Preferred embodiments of the present invention will be described below with reference to the accompanying drawings, wherein like reference numerals refer to like elements throughout. The following description begins with an overview of the present invention and then proceeds to a more specific embodiment of the invention.

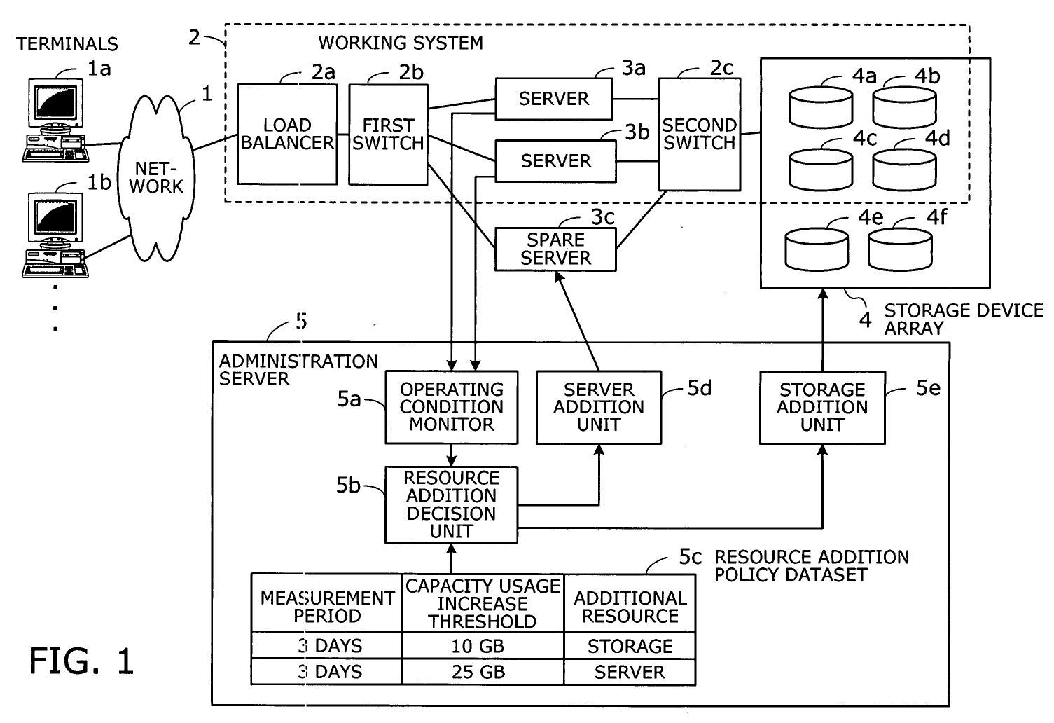

FIG. 1 is a conceptual view of the present invention. Illustrated is a system that serves the users sitting at their terminals 1a and 1b, and so on via a network 1. Specifically, a working system 2 employs a plurality of servers 3a and 3b, as well as a storage device array 4 containing a plurality of storage devices 4a, 4b, 4c, and 4d. The servers 3a and 3b are connected to the network 1 via a load balancer 2a and a first switch 2b. The storage devices 4a to 4d are coupled to the servers 3a and 3b via a second switch 2c.

Also connected to the working system 2 is a spare server 3c. More specifically, this spare server 3c is connected to the first and second switches 2b and 2c in the working system 2. The spare server 3c is in a standby state and currently providing users with no particular services.

Further connected to the working system 2 are spare storage devices 4e and 4f, as part of the storage device array 4. Those two spare storage devices 4e and 4f are deactivated, and no access is allowed from the working system 2.

The above system is under the control of an administration server 5. The administration server 5 has the following functional elements: an operating condition monitor 5a, a resource addition decision unit 5b, a resource addition policy dataset 5c, a server addition unit 5d, and a storage addition unit 5e. Functions of those elements are as follows:

The operating condition monitor 5a observes current load of the working system 2. The task includes, for example, monitoring current usage of storage devices coupled to the servers 3a and 3b. With reference to a resource addition policy dataset 5c, the resource addition decision unit 5b determines whether it is necessary to add hardware resources to the working system 2, as well as what kind of hardware resources should be added if it is the case, according to the degree of increase in the system load observed by the operating condition monitor 5a.

The resource addition policy dataset 5c provides policy rules about whether to add a server or a storage device, depending on the degree of increase in the load of hardware resources that is observed within a predetermined time period during system operations. More specifically, the resource addition policy dataset 5c defines a set of rules about what resources are to be added when a certain amount of increase is observed in the used capacity during a period that is specified as measurement period. In the example of FIG. 1, it gives a rule stating that a storage device will be added if the observed increase of used capacity in a three-day period is equal to or greater than 10 gigabytes (GB) and smaller than 25 GB. Also stated is such a rule that a server will be added if the used capacity has increased by 25 GB or more in a three-day period.

If it is determined that an additional server is required, the server addition unit 5d activates the spare server 3c, which is already connected to the working system 2, but has thus far been in a standby state. If it is determined that an additional storage device is required, the storage addition unit 5e permits the working system 2 to make access to spare storage devices 4e and 4f. The spare storage devices 4e and 4f have been connected to the working system 2 physically, but the access from the working system 2 has thus far been blocked.

To summarize the above, the administration server operates as follows. Based on the current load condition of the working system 2 observed by the operating condition monitor 5a, the resource addition decision unit 5b determines whether the working system 2 needs additional hardware resources and what kind of resources they should be, according to a given resource addition policy dataset 5c. When it is determined that an additional server is required, the server addition unit 5d activates a spare server 3c. When it is determined that an additional storage device is required, the storage addition unit Se activates spare storage devices 4e and 4f, so that the working system 2 can make access to them.

That is, the necessity of additional hardware resources is determined according to the current load condition of the working system 2, and an appropriate additional resource is added promptly to the system that is in operation. With a predefined resource addition policy dataset 5c shown in FIG. 1, for example, the administration server 5 can make an adequate choice between an additional server or an additional storage device, depending on how fast the used storage space is increasing.

For a system offering different classes of services, the proposed administration server has a capability of choosing the type of hardware resources on an individual service basis. As a specific embodiment of the present invention, the following section will now describe in detail a system that supplies lacking hardware resources automatically.

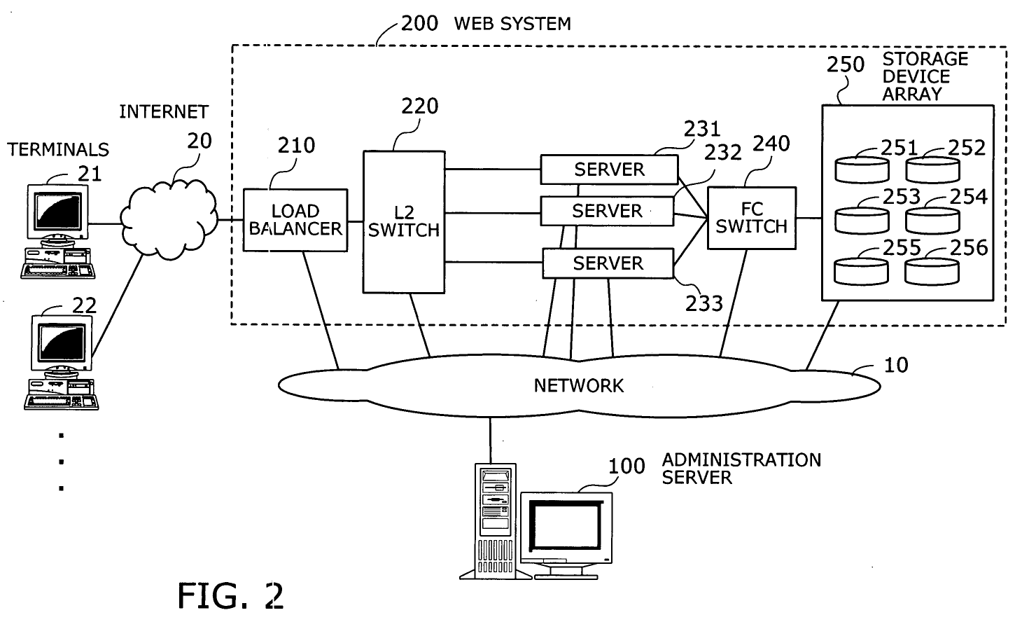

FIG. 2 shows a system configuration according to an embodiment of the present invention. The illustrated web system 200 provides various services to a plurality of terminals 21 and 22 via the Internet 20. While FIG. 2 shows only two terminals 21 and 22 for the purpose of simplicity, it should be appreciated that there are many such terminals capable of having access to the web system 200.

The web system 200 is under the control of an administration server 100, which is linked to the web system 200 through a network 10. The web system 200 is formed from the following components: a load balancer 210, a layer-2 (L2) switch 220, a plurality of servers 231, 232, and 233, a fiber channel (FC) switch 240, and a storage device array 250 containing multiple storage devices 251 to 256.

The load balancer 210 is connected to the Internet 20 to communicate with the terminals 21 and 22. By monitoring processing load and other conditions of active servers, the load balancer 210 distributes service requests from the terminals 21 and 22, so that the workload of requested tasks will not concentrate on particular servers. Placed between the load balancer 210 and servers 231 to 233 is an L2 switch 220, which forwards service requests to their destination servers as specified by the load balancer 210.

The servers 231, 232, and 233 execute requested tasks according to each service request from the terminals 21 and 22, as well as returning them responses including processing results. Basically, at least one of the plurality of servers 231, 232, and 233 is reserved as a spare server. The spare server is exempted from any service tasks, while letting other servers deal with them. The working servers 231, 232, and 233 make access to the storage device array 250 when they need to do so in order to accomplish their tasks.

The FC switch 240, disposed between the servers 231, 232, and 233 and the storage device array 250, receives storage access commands from the servers 231, 232, and 233 and forwards them to respective destination storage devices. The storage device array 250 manages a plurality of storage devices 251 to 256. At least one of those storage devices 251 to 256 is reserved as a spare storage device, while the others are in active use by the servers.

The administration server 100 is linked to individual components of the web system 200 via a network 10, so that it can collect information about each component's operating status. When the web system 200 does not have enough hardware resources to provide a specific service, the administration server 100 determines which additional hardware resource (e.g., server or storage device) should be added. The administration server 100 then reconfigures the web system 200 so that the newly incorporated hardware resource will be used for the service.

End users sitting at their terminals 21 and 22 use services provided by the web system 200. More specifically, each service is made available in a corresponding virtual local area network (VLAN) environment with a unique VLAN ID. That is, the server system is virtually divided into a plurality of network segments. Further, each service is associated with a uniform resource locator (URL) which is specific to that service. End users can receive a particular service by making access to the associated URL from their terminals 21 and 22. In the case a plurality of servers offer the same service, the load balancer 210 distributes the workloads across those servers.

The environments for providing services are uniform in terms of physical and logical configurations of servers, except for Internet Protocol (IP) addresses. Such a server environment can be set up by using master image data. All setup information (e.g., VLAN ID, IP address range, master image, storage capacity requirements) that is necessary for a server to provide a particular service is defined as a set of policies and stored in the administration server 100. While being deployed as a separate system component independent of the web system 200, the administration server 100 is allowed to communicate, at the IP level, with all managed devices in the web system 200.

The above-described system permits an additional server or storage device to be installed according to the need of individual services. More specifically, the administration server 100 measures the amount of storage space consumed by a particular service at predetermined intervals and compares the observed increase with a service-specific threshold, thus determining whether to add a storage device alone or to place an extra server. If the latter option is taken, the administration server 100 transfers an image copy of operating system and application software to the server to be added. The server then starts up with the operating system and becomes ready to receive an IP address assignment and the like from the administration server 100.

To establish a new system configuration, the administration server 100 retrieves necessary data files from an existing storage device and copies them to a new storage device. In addition, the administration server 100 instructs the load balancer 210 to associate the newly installed server with a specified service. The administration server 100 also reconfigures the FC switch 240 and other related system components so that a new storage device can be accessed from corresponding servers.

### Hardware Platforms

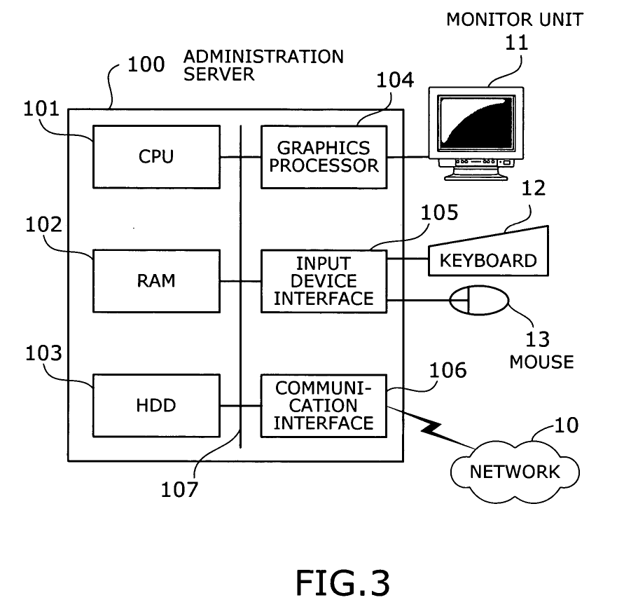

FIG. 3 shows an example of a hardware platform for an administration server used in the present embodiment of the invention. The administration server 100 employs a central processing unit (CPU) 101 that controls the entire computing facilities while interacting with other elements via a common bus 107, which include: a random access memory (RAM) 102, a hard disk drive (HDD) 103, a graphics processor 104, an input device interface 105, and a communication interface 106.

The RAM 102 serves as temporarily storage for the whole or part of operating system (OS) programs and application programs that the CPU 101 executes. It also stores other various data objects manipulated by the CPU 101 at runtime. The HDD 103 stores program and data files of the operating system and various applications. The graphics processor 104 produces video images in accordance with drawing commands from the CPU 101 and displays them on a screen of an external monitor unit 11 coupled thereto. The input device interface 105 is used to receive signals from external input devices, such as a keyboard 12 and a mouse 13. Those input signals are supplied to the CPU 101 via the bus 107. The communication interface 106 is connected to a network 10, allowing the CPU 101 to exchange data with other computers (not shown) on the network 10.

A computer with the above-described hardware configuration serves as a platform for realizing the processing functions of the present embodiment. While FIG. 3 only shows a hardware structure of the administration server 100, the illustrated structure can also be applied to other system components such as terminals 21 and 22 and servers 231, 232, and 233.

### Administration Server Functions

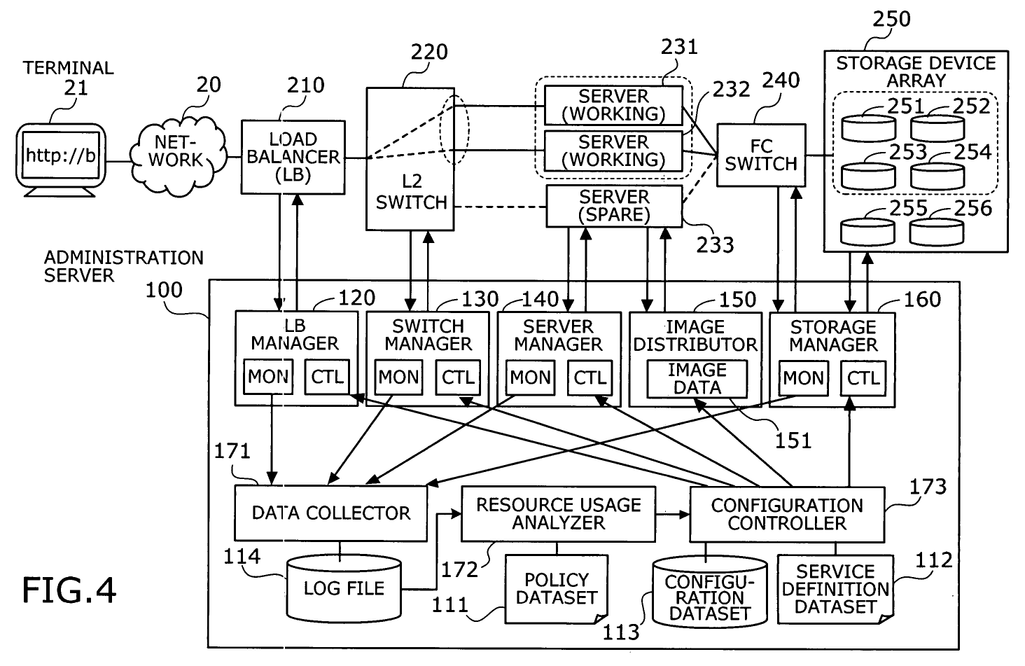

Referring next to FIG. 4, processing functions of the administration server 100 will be described below. In the example of FIG. 4, two servers 231 and 232 are activated, while the remaining server 233 is in a standby state. In the storage device array 250, four storage devices 251 to 256 are activated, while the remaining two storage devices 255 and 256 are reserved.

The administration server 100 stores several datasets for administrative purposes, which are: a policy dataset 111, a service definition dataset 112, a configuration dataset 113, and a log file 114. The policy dataset 111 defines resource management rules applicable to various situations that the web system 200 may encounter. The service definition dataset 112 contains records about what services the web system 200 can offer, and what resources are required to provide those services. The configuration dataset 113 contains records indicating currently available services and their respective resource allocations. The log file 114 has a collection of log records showing the past operating conditions of the web system 200.

Also included in the administration server 100 are: a load balancer (LB) manager 120, a switch manager 130, a server manager 140, an image distributor 150, and a storage manager 160. The administration server 100 uses those components to monitor the operating condition of the web system 200, as well as to remotely control the web system 200 when it has to be reconfigured. In FIG. 4, the small boxes with a caption “MON” represent such monitoring functions, while those with a caption “CTL” represent control functions.

The load balancer manager 120 controls the load balancer 210 while monitoring its operating condition. The load balancer 210 needs such external control when, for example, it begins forwarding incoming service requests to a newly added server. The switch manager 130 controls the L2 switch 220, as well as monitoring its operating condition. The server manager 140 controls servers 231, 232, and 233, as well as monitoring their respective operating conditions. The servers 231, 232, and 233 require such external control when, for example, a new storage device is installed for use in offering services.

The image distributor 150 maintains multiple sets of image data 151 for delivery of system disk image files to a requesting server. The term “image data” refers to program and data backup files for operating system and applications stored in a system disk. The image distributor 150 transfers an appropriate set of image data to a new server's system disk, which enables the server to boot up with the backed-up operating system. Another function of the image distributor 150 is to help a server to set up its operating environment with the received image data 151.

The storage manager 160 controls the FC switch 240 and storage device array 250 while monitoring their respective operating conditions.

The administration server 100 has more components to establish a new system configuration, which are: a data collector 171, a resource usage analyzer 172, a configuration controller 173. The data collector 171 gathers records concerning operating conditions of the web system 200. The web system 200 is monitored in a distributed manner by the load balancer manager 120, switch manager 130, server manager 140, and storage manager 16U in the administration server 100. The log file 114 is where the gathered records reside. The resource usage analyzer 172 retrieves data from the log file 114 for comparison with entries of the policy dataset 111. The resource usage analyzer 172 then determines, for each service, whether it is necessary to add hardware resources and, if it is, what hardware resource is suitable.

Upon determination of resources to be added for use in a particular service, the configuration controller 173 consults a service definition dataset 112 to find what operating environment (e.g., IP address) the service requires. Additionally, the configuration controller 173 consults a configuration dataset 113 to determine which server is currently responsible for the service of interest, and it formulates a new configuration for the system. The configuration controller 173 then sends commands to the load balancer manager 120, switch manager 130, server manager 140, image distributor 150, and storage manager 160. Those commands request them to control the resources for which they are responsible, such that the new system configuration will be established. Lastly, the configuration controller 173 updates the configuration dataset 113 with the new configuration.

### Administrative Datasets

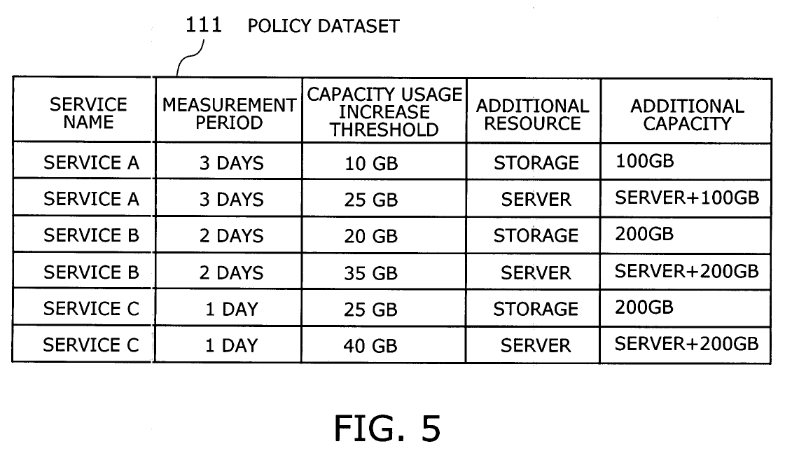

With reference to some specific examples, this section gives more details about various administrative datasets stored in the administration server 100. FIG. 5 shows an example data structure of a policy dataset. This policy dataset 111 has the following data fields: “Service Name,” “Measurement Period,” “Capacity Usage Increase Threshold,” “Additional Resource,” and “Additional Capacity.” A record concerning resource addition policies is formed from such data items associated in the same row.

Specifically, the “Service Name” field contains the name of a service which may require additional resources. The “Measurement Period” field gives a measurement period during which the operating state is observed to determine the necessity of additional resources. The “Capacity Usage Increase Threshold” field defines a threshold of storage capacity usage for determining the need for additional resources. In the present example of FIG. 5, several policy rules are defined for different amounts of capacity usage in units of gigabytes (GB). The “Additional Resource” field specifies what type of resources is to be added when it is necessary. The “Additional Capacity” field specifies the amount of storage capacity to be added.

The first record of the dataset, for example, gives such a rule that a 100-GB storage device should be added if an increase of 10 GB or more is observed in storage usage of service A during a three-day period. The second record means that an extra server will be required if an increase of 25 GB or more is observed in storage usage of service A during a three-day period. The second record further states that, if this is the case, an additional storage device with a capacity of 100 GB has to be installed, along with the additional server.

The policy dataset 111 of FIG. 5 actually contains a two or more records that may overlap one another. For instance, the conditions of the first and second records explained above are both satisfied when the service A has used another 25 GB or more in a three-day period. In such cases, the record with a largest value of “Capacity Usage Increase Threshold” will be applied.

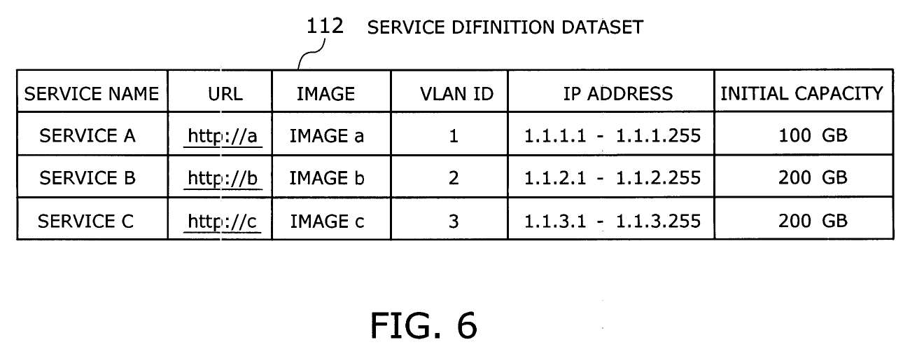

FIG. 6 shows an example data structure of a service definition dataset. This service definition dataset 112 has the following data fields: “Service Name,” “URL,” “Image,” “VLAN ID,” “IP Address,” and “Initial Capacity.” A record concerning each particular service is formed from such data items associated in the same row.

The “Service Name” field contains the name of a service which is available from the web system 200. Note that all other data items in the same record are related to that particular service. Specifically, the “URL” field contains a URL that is assigned to that service. The “Image” field gives the name of image data to be delivered to a server when it starts offering that service. The “VLAN ID” field contains an identifier of VLAN for that service. The “IP Address” field gives a range of IP addresses that can be assigned to a server when it starts offering that service. The “Initial Capacity” field specifies a minimum capacity of storage devices required to make that service available.

Take the first record, for example. This record indicates first that service A is to be available at “http://a.” It also says that the server providing this service A receives “image data a.” Service A forms a VLAN environment with VLAN ID=1 and is allowed to use an IP address selected from a range of “1.1.1.1” to “1.1.1.255.” When a server starts offering service A, the server is assigned a storage device with a capacity of 100 GB.

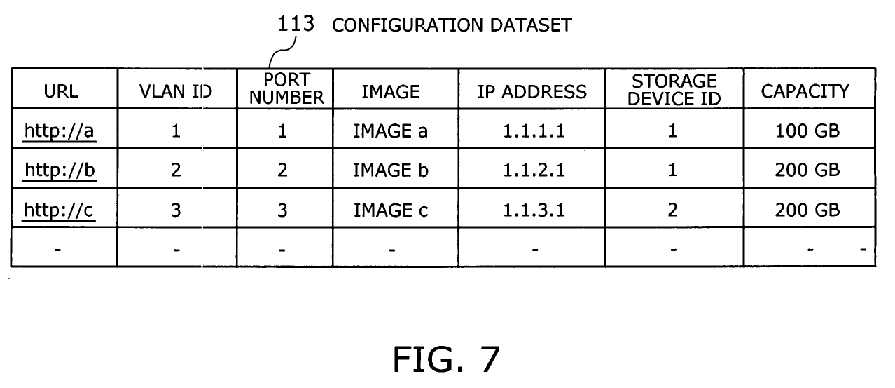

FIG. 7 shows an example of a configuration dataset. This configuration dataset 113 has the following data fields: “URL,” “VLAN ID,” and “Port Number,” “Image,” “IP Address,” “Storage Device ID,” and “Capacity.”

The “URL” field contains a URL of a service that is currently available. The “VLAN ID” field shows the identifier of a VLAN to which the server providing the service belongs. The “Port Number” field gives a port number of the L2 switch 220 to which the service-providing server is linked. The “Image” field contains the name of image data that was delivered to the service-providing server. The “IP Address” field shows the IP address currently used by the service-providing server. The “Storage Device ID” field stores the identification code of a storage device that is used to offer the service. The “Capacity” field shows the amount of storage capacity assigned to the services.

The configuration dataset 113 shows the current setup of the web system 200. For example, the service available at URL “http://a” is currently provided by a server working in a VLAN environment with VLAN ID=1. That server has an IP address of “1.1.1.1,” and it received “image data a” when it started up. The service is allowed to use a storage capacity of up to 100 GB, which is available in the storage device with an identification code of “1.”

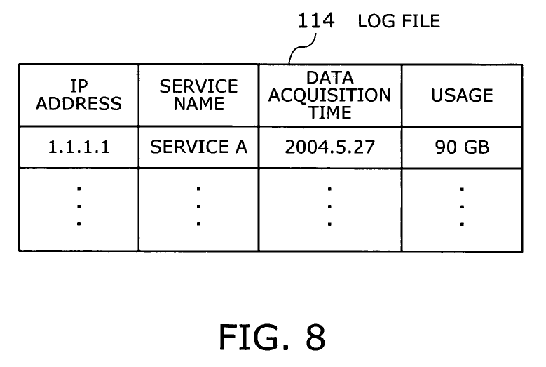

FIG. 8 shows an example data structure of a log file. This log file 114 has the following data fields: “IP Address,” “Service Name,” “Data Acquisition Time,” and “Usage.” A record concerning load condition is formed from such data items associated in the same row. Specifically, the “IP Address” field shows the IP address of a server which sent out data in providing a particular service, and the “Service Name” field shows the name of that service. The “Data Acquisition Time” field contains a timestamp indicating when this log record was created. The “Usage” field indicates the usage level of a storage device assigned to the service.

### Administration Server Process Flow

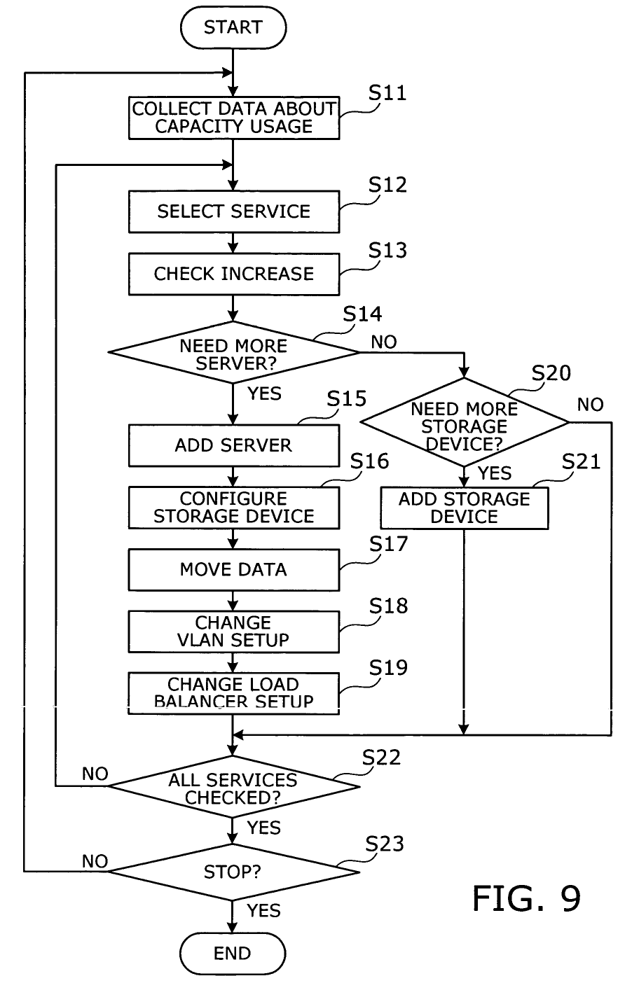

With the functions and data described in the preceding sections, the administration server 100 operates as shown in the flowchart of FIG. 9. Specifically, FIG. 9 shows how the administration server 100 allocates additional resources. This process includes the following steps:
(Step S11) The data collector 171 consults the server manager 140 to collect data about how much capacity in the storage device array 250 is actually used by each individual service.
   More specifically, the server manager 140 sends a message requesting the working servers 231 and 232 to report their actual storage capacity usage for each service that they provide. In response to this request, each server 231 and 232 sends information about its service-specific storage usage back to the server manager 140. The received information is passed to the data collector 171. The data collector 171 collects those data records about service-specific storage usage and writing them into a log file 114.
   Every service has its own directory in the file system, and the amount of data stored under that directory can be added up. In this step S11, the servers 231 and 232 make such calculation for each service and report the result to the server manager 140.
(Step S12) The resource usage analyzer 172 selects one service from among those provided by the web system 200.
(Step S13) By consulting the log file 114, the resource usage analyzer 172 evaluates the increase in capacity usage during a given measurement period for the selected service.
   More specifically, the resource usage analyzer 172 first extracts necessary log records out of the log file 114, while skipping those unrelated to the service selected at step S12. What is extracted here is a latest set of records and an old set of records that were collected in the preceding measurement cycle (the measurement interval is specified in the “Measurement Period” field of the policy dataset 111. Now that data is ready, the resource usage analyzer 172 compares the latest records with the past records, thereby identifying the amount of increase in storage capacity usage.
(Step S14) The resource usage analyzer 172 determines whether it is necessary to allocate an extra server to the selected service.
   More specifically, the resource usage analyzer 172 compares the observed increase in storage capacity usage of the selected service with each capacity usage increase threshold defined in the policy dataset 111. If the increase equals or exceeds one such threshold, the resource usage analyzer 172 looks into the corresponding “Additional Resource” field of the policy dataset 111, thus determining what is required in the present situation. If this data field indicates the need for an additional server, the resource usage analyzer 172 advances to step S15. If not, the process branches to step S20.
(Step S15) Now that the need for a server is established, the configuration controller 173 begins actual tasks of allocating a server to the selected service.
   More specifically, the configuration controller 173 consults the service definition dataset 112 to determine which image data, VLAN ID, and IP address should be sent to the new server. The configuration controller 173 then issues a data delivery request to the image distributor 150, specifying which image data to send. This request causes the image distributor 150 to transmit specified image data files to a reserved server. The received image data is loaded into the server's local system disk where the operating system is supposed to be stored, so that the server can execute OS and other functions on the basis of the received image data. The image distributor 150 further establishes an operating environment for the server by using VLAN ID and IP address determined by the configuration controller 173.
(Step S16) The configuration controller 173 configures the storage device system.
   More specifically, the configuration controller 173 checks the “Additional Capacity” field of the policy dataset 111, thus determining what resources should be added. The configuration controller 173 requests the storage manager 160 to allocate a specified amount of additional storage space to the service. In response to this request, the storage manager 160 reserves the requested amount of space in the storage device array 250. The storage manager 160 also reconfigures the FC switch 240, so that the reserved space can be available to the service selected at step S12.
(Step S17) The configuration controller 173 moves service-related data. More specifically, the configuration controller 173 commands the storage manager 160 to move the data pertaining to the selected service to the newly reserved storage space. The storage manager 160 controls the storage device array 250 to transport necessary data according to that command.
(Step S18) The configuration controller 173 changes VLAN setup. More specifically, the configuration controller 173 instructs the server manager 140 to register the new server as a member node of the VLAN determined at step S15. The server manager 140 sets up the server environment accordingly.
(Step S19) The configuration controller 173 changes setup of the load balancer 210. More specifically, the configuration controller 173 requests the load balancer manager 120 to make the load balancer 210 recognize the new server as one of the destinations of incoming requests for the selected service. The load balancer manager 120 reconfigures the load balancer 210 accordingly. Upon completion or this setup, the configuration controller 173 updates the configuration dataset 113 to include a new entry of service configuration. The process then proceeds to step S22.
(Step S20) Since the test at step S14 indicates no need for additional servers, the resource usage analyzer 172 now determines whether the selected service requires more storage space.
   More specifically, the resource usage analyzer 172 compares the observed increase in storage capacity usage of the selected service with each relevant capacity usage increase threshold defined in the policy dataset 111. If the increase equals or exceeds one such threshold, the resource usage analyzer 172 looks into the corresponding “Additional Resource” field of the policy dataset 111 to determine what is required in the present situation. If this data field indicates the need for an additional storage device, the resource usage analyzer 172 advances to step S21. If not, the process skips to step S22.
(Step S21) The configuration controller 173 adds a new storage device.
   More specifically, the configuration controller 173 determines how much additional storage capacity is required, by consulting the “Additional Capacity” field of the policy dataset 111. The configuration controller 173 requests the storage manager 160 to allocate the specified amount of additional storage space to the service. In response to this request, the storage manager 160 reserves the requested amount of space in the storage device array 250. The storage manager 160 also reconfigures the FC switch 240, so that the reserved space can be available to the service selected at step S12. The configuration controller 173 then updates the configuration dataset 113 with the new configuration.
(Step S22) The resource usage analyzer 172 determines whether there is any unchecked service. If there is, the process returns to step S12. If all existing services have been checked, the process advances to step S23.
(Step S23) The data collector 171 determines whether there is an instruction to stop this additional resource allocation process. If there is, the process is terminated. If not, the process returns the step S11 to repeat the above steps.

The content of the configuration dataset 113 is kept up to date, since each time a new resource is added for a particular service, the configuration controller 173 updates the configuration dataset 113 with a new configuration. See, for example, the second record of the service definition dataset 112 (FIG. 6) and configuration dataset 113 (FIG. 7). This service B is made available at “http://b” by the server with an IP address “1.1.2.1.” Suppose that the service B has consumed another 35 GB or more space in two days. The administration server 100 now has to allocate an extra server and an additional storage device of 200 GB, as defined in the policy dataset 111 (FIG. 5). The configuration controller 173 thus reconfigures the web system 200. The new system configuration is then registered with the configuration dataset 113.

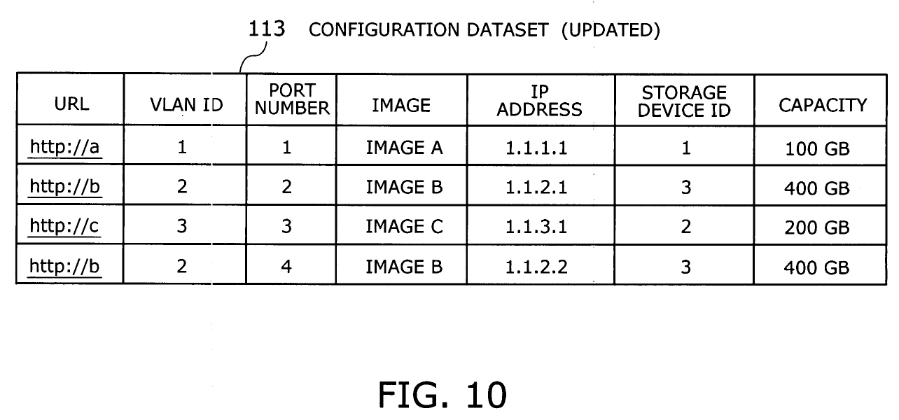

FIG. 10 shows the updated configuration dataset. Compared with the previous configuration dataset 113 (FIG. 7), the updated version has a new record that says: URL=“http://b,” VLAN ID=2, Port number=4, Image=“Image B,” IP address=1.1.2.2, Storage Device ID=3, and Capacity=400 GB. This record describes current resource allocation for the newly added server.

Notice that service B is now supported by two servers. When two or more servers work for the same service, as in the case of service B, those servers share the same set of data for that service. For this reason, the second record in the configuration dataset 113 of FIG. 10 has also been changed as a result of installation of a new server. Specifically, the existing server (the one with an IP address of “1.1.2.1”) is now using a storage device “3” with a capacity of 400 GB, which were “1” and 200 GB, respectively, before a server was added.

In the way described above, the administration server 100 finds resources that the web system 200 is lacking and allocates what is required (i.e., server or storage device or both) to the service in need.

### Resource Management Based on CPU Load

According to another aspect of the invention, the administration server 100 may be designed to monitor the CPU load of working servers and determine whether or not to add another server. In this case, the administration server 100 employs a new policy dataset, called “server addition policy dataset.”

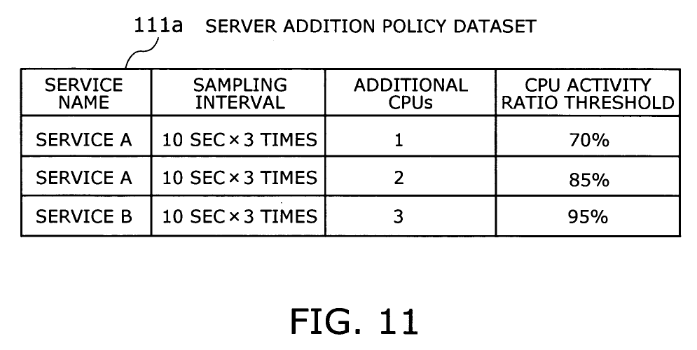

FIG. 11 shows an example data structure of CPU load-based server addition policy. The illustrated server addition policy dataset 111a has the following data fields: “Service Name,” “Sampling Interval,” “Additional CPUs,” and “CPU Activity Ratio Threshold.” A record concerning server addition policy is formed from such data items associated in the same row.

The “Service Name” field contains the name of a service. The “Sampling Interval” field specifies a sampling interval and the number of times that CPU activity ratio should be monitored at the specified intervals. The “Additional CPUs” field gives the number of CPUs to be added when the observed CPU activity ratio is greater than a threshold specified in the next data field titled “CPU Activity Ratio Threshold.” Note that the determination uses an average of CPU activity ratios observed during the specified sampling interval.

According to the first record, for example, the CPU activity ratio in service A is to be sampled three times at the intervals of ten seconds. If the average result is 70% or more, one additional CPU will be allocated to service A.

The server addition policy dataset 111a of FIG. 11 actually contains a two or more records that may overlap one another. For instance, the conditions of the first and second records are both satisfied when the CPU activity ratio of service A has reached 85%. In such cases, the record with a largest value in “CPU Activity Ratio Threshold” field will be applied.

With the above-described server addition policy dataset 111a, the administration server 100 operates as follows: First of all, the data collector 171 collects data about CPU activity ratios in each server at given sampling intervals. The data collector 171 performs this task in cooperation with the server manager 140. Subsequently, the resource usage analyzer 172 calculates an average CPU activity ratio from a predetermined number of samples and compares the result with a given threshold. It determines that the system needs server enhancement, if the resulting average CPU activity ratio is not smaller than the threshold.

In adding a server to the system, the configuration controller 173 selects an appropriate server with a performance equivalent to what is specified in the “Additional CPU” field. The configuration controller 173 commands the image distributor 150 to send image data to the spare server. Upon startup of the server, the image distributor 150 helps the server set up its IP address. The storage manager 160, on the other hand, reserves a required amount of storage space in the storage device array 250, and it configures the FC switch 240 such that the new server can make access to that reserved storage device. The switch manager 130 is responsible for setting up the L2 switch 220 such that the new server can enroll as a member node of a specified VLAN. The configuration controller 173 also instructs the load balancer 210 to associate a newly installed server with a specified service. In this way, the administration server 100 of the present embodiment adds a server and other resources to the managed system according to the observed CPU activity ratios.

### Resource Management based on Load Balancing

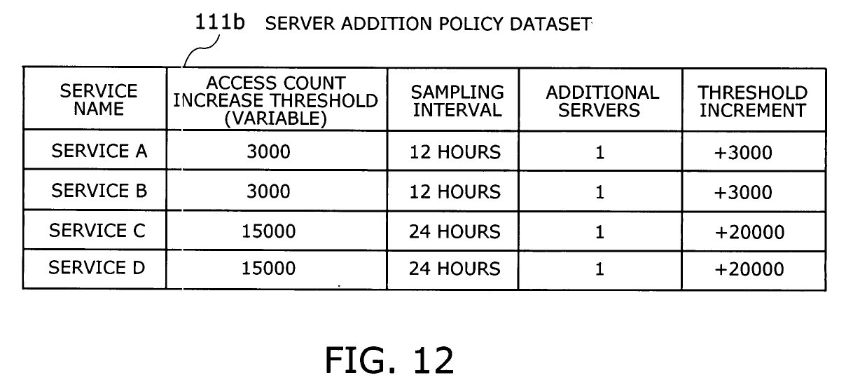

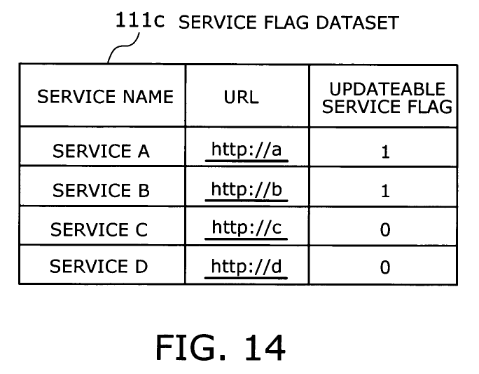

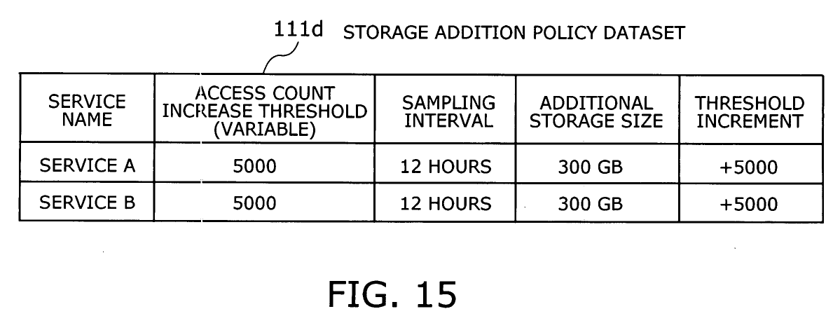

According to yet another aspect of the present invention, the administration server 100 may be designed to determine the necessity of additional resources, based on how many service requests the load balancer 210 is handling. At predetermined sampling intervals, the load balancer manager 120 records the access count of each service that it handles. Based on this access count, the resource usage analyzer 172 determines whether it is necessary to add a server or a storage device or both. In the following example, a new set of policy definitions are used in place of the policy dataset 111 described earlier in FIG. 4. They are: a server addition policy dataset (FIG. 12), a service flag dataset (FIG. 14), and a storage addition policy dataset (FIG. 15).

FIG. 12 shows an example data structure of server addition policies based on the number of accesses handled by a load balancer. The illustrated server addition policy dataset 111b has the following data fields: “Service Name,” “Access Count Increase Threshold,” “Sampling Interval,” “Additional Servers,” and “Threshold Increment.” A record concerning server addition policy is formed from such data items associated in the same row.

The “Service Name” field contains the name of a service. The “Access Count Increase Threshold” field contains a threshold value for access count increase, which is used to determine whether or not to install an additional server. Note that this is a variable threshold, which increases each time a new server is added, as will be described later. The “Sampling Interval” field specifies at what intervals a new access count should be collected. The “Additional Servers” field gives the number of servers to be added when the observed access count increase is greater than the variable threshold. The “Threshold Increment” field specifies an increment of the access count increase threshold, which applies each time a new server is added.

Suppose, for example, that the current access count increase threshold is set to 3,000 for service A. The load balancer 210 reports at predetermined intervals how many access requests for service A it has routed to corresponding servers. If a new access count exceeds the previous count by 3,000 or more, the administration server 100 allocates another server to service A, and at the same time, the threshold is increased by an increment of 3,000.

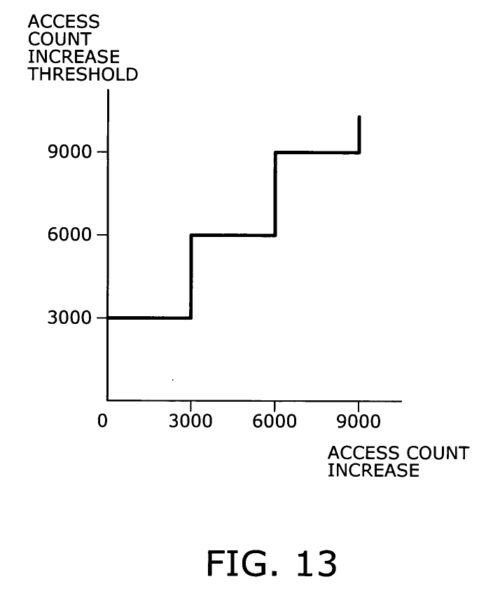

FIG. 13 shows the relationship between the access count increase of service A and access count increase threshold. The horizontal axis represents access count, and the vertical axis represents access count increase threshold. As can be seen from FIG. 13, the access count increase threshold stays at a constant level of 3,000 until the actual access count increase reaches 3,000. If the access count reaches the first threshold of 3,000, then the threshold goes up to the next level, 6,000, with an increment of 3,000. Likewise, the access count increase threshold is raised by 3,000 each time the actual increase reaches it.

FIG. 14 shows an example data structure of a service flag dataset. This service flag dataset 111c has three data fields titled “Service Name,” “URL,” and “Updateable Service Flag.” Those data items in each row form an associated set of information, or a record, that indicates whether the service in question is an updateable data service.

The “Service Name” field contains the name of a service, and the “URL” field indicates the URL of that service. The “Updateable Service Flag” field contains a flag showing whether the service in question is an updateable data service, i.e., whether the service allows users to update its data. For example, electronic mail services fall under the category of updateable data services since they provide users with a storage space for storing received messages. Non-updateable data services, on the other hand, include simple information providing services that only allow the users to browse their web pages.

Updateable data services tend to consume more and more storage space as the number of accesses increases. For this reason, an increase in the access count calls for consideration of additional storage devices, as well as of server enhancement. In contrast, non-updateable data service are free from worries about storage space consumption, no matter how much the access count increases. Increased access to a non-updateable data service may actually necessitate server addition, but it will not require extra storage devices. The service flag dataset of FIG. 14 makes distinctions between updateable and non-updateable data services by setting a corresponding updateable service flag to “1” for the former, and “0” for the latter.

FIG. 15 shows an example data structure of a storage addition policy dataset. This storage addition policy dataset 111d has the following data fields: “Service Name,” “Access Count Increase Threshold,” “Sampling Interval,” “Additional Storage Size,” and “Threshold Increment.” A record concerning storage addition policy is formed from such data items associated in the same row.

The “Service Name” field contains the name of a service. The “Access Count Increase Threshold” field contains a threshold value for the access count increase, which is used to determine whether or not to install an additional storage device. Note that it is a variable threshold, which increases each time a new storage device is added. The “Sampling Interval” field specifies at what intervals a new access count should be collected. The “Additional Storage Size” field gives a storage capacity to be added when the observed access count increase exceeds the variable threshold. The “Threshold Increment” field specifies an increment of the access count increase threshold, which applies each time a new storage device is added.

Suppose, for example, that the current access count increase threshold is set to 5,000 for service A. At predetermined intervals, the load balancer 210 reports how many access requests for service A it has routed to corresponding servers during each given period. If a new access count exceeds the previous count by 5,000 or more, the administration server 100 allocates an additional 300-GB storage device to service A, and at the same time, the threshold is increased by an increment of 5,000.

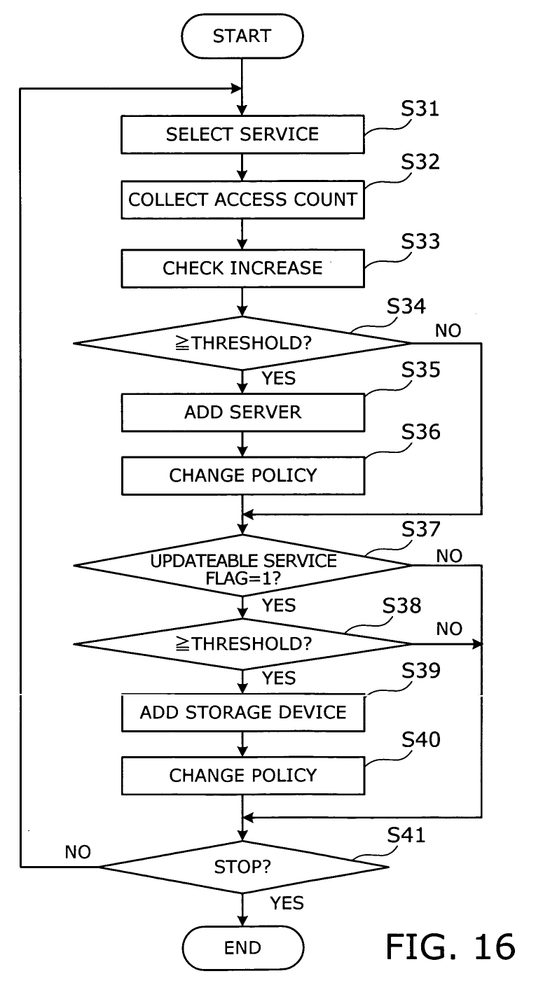

FIG. 16 is a flowchart of a resource addition process based on the actual number of service requests distributed from a load balancer. This process includes the following steps:
(Step S31) The data collector 171 selects a service whose sampling interval has expired. (The sampling period is specified in the server addition policy dataset 111b.)
(Step S32) The data collector 171 communicates with the load balancer manager 120 to collect a new access count of the service selected at step S31.
   More specifically, the server manager 140 sends a message requesting the load balancer 210 to report a new access count of the service in question. In response to this request message, the load balancer 210 sends back the number of accesses made to the specified service during a predetermined period. The load balancer manager 120 passes the received data to the data collector 171. The data collector 171 records this service access count in a log file 114.
(Step S33) By consulting the log file 114, the resource usage analyzer 172 evaluates the increase in access count of the selected service.
   More specifically, the resource usage analyzer 172 first extracts necessary log records out of the log file 114, while skipping those unrelated to the service selected at step S31. What is extracted here is a latest record and an old record that was collected in the preceding sampling cycle. The resource usage analyzer 172 then compares the two records, thereby identifying the amount of increase in access count.
(Step S34) The resource usage analyzer 172 compares the observed access count increase with each access count increase threshold defined in the server addition policy dataset 111b. If the observed increase equals or exceeds one such threshold, the resource usage analyzer 172 determines that a server has to be added, thus advancing the process to step S35. If the observed increase is still below the threshold, the process skips to step S37.
(Step S35) Now that the need for a server is established, the configuration controller 173 begins actual tasks of allocating a server to the selected service.
(Step S36) The configuration controller 173 updates the “Access Count Increase Threshold” field of the server addition policy dataset 111b.
(Step S37) The resource usage analyzer 172 consults the service flag dataset 111c to determine whether the service selected at step S31 has an updateable service flag being set to one. That is, it is tested whether the selected service is an updateable data service or a non-updateable data service. If the flag is set to one, the process advances to step S38. If it is zero, the process skips to step S41.
(Step S38) The resource usage analyzer 172 compares the observed access count increase with each access count increase threshold defined in the storage addition policy dataset 111d. If the observed increase equals or exceeds one such threshold, the resource usage analyzer 172 determines that a storage device has to be added, thus advancing the process to step S39. If the observed increase is still below the threshold, the process skips to step S41.
(Step S39) The configuration controller 173 adds a storage device according to the storage addition policy data 111d.
(Step S40) The configuration controller 173 updates the “Access Count Increase Threshold” field of the storage addition policy dataset 111d.
(Step S41) The data collector 171 determines whether there is an instruction to stop this additional resource allocation process. If there is, the process is terminated. If there is, the process returns to step S31.

The above sequence of processing steps permits the administration server 100 to select an appropriate resource based on a service-specific access count. The proposed process also checks whether the service in question is an updateable data service before allocating a storage device, thus preventing unnecessary addition from happening.

### Program Storage Media

The above-described processing mechanisms of the present invention are implemented on a computer system. The functions necessary for realizing a data management device are encoded and provided in the form of computer programs. The computer system executes such programs to provide the intended functions of the present invention. For the purpose of storage and distribution, the programs are stored in a computer-readable storage medium, which include: magnetic storage media, optical discs, magneto-optical storage media, and solid state memory devices. Magnetic storage media include hard disk drives (HDD), flexible disks (FD), and magnetic tapes. Optical discs include digital versatile discs (DVD), DVD-RAM, compact disc read-only memory (CD-ROM), CD-Recordable (CD-R), and CD-Rewritable (CD-RW). Magneto-optical storage media include magneto-optical discs (MO).

Portable storage media, such as DVD and CD-ROM, are suitable for the distribution of program products. Network-based distribution of software programs is also possible, in which master program files are made available in a server computer for downloading to user computers via a network.

A user computer stores necessary programs in its local storage unit, which have previously been installed from a portable storage media or downloaded from a server computer. The computer performs intended functions by executing the programs read out of the local storage unit. As an alternative way of program execution, the computer may execute programs, reading out program files directly from a portable storage medium. Another alternative method is that the user computer dynamically downloads programs from a server computer when they are demanded and executes them upon delivery.

### CONCLUSION

The present invention proposes a mechanism of determining what kind of hardware resources are lacking in the managed system, depending on the degree of increase in the system load. This feature makes it possible to select and allocate an appropriate resource to the system.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A system configuration management program for adding hardware resources to a system in operation, the program causing a computer to function as:
an operating condition monitor that observes load of the system in operation;
a resource addition decision unit that determines whether it is necessary to add hardware resources to the system, and what kind of hardware resources should be added, according to the degree of increase in the load observed in a predetermined period, with reference to a resource addition policy dataset that provides policy rules including whether to add a server or a storage unit;
a server addition unit that activates a spare server if the resource addition decision unit determines that an additional server is required, the spare server having thus far been connected to the system as a spare resource in a standby state; and
a storage addition unit that permits the system to make access to a spare storage device if the resource addition decision unit determines that an additional thus far been connected to the system as a spare resource that cannot be accessed from the system.

2. The system configuration management program according to claim 1, wherein:
the system offers a plurality of services;
the operating condition monitor observes load of each individual service;
the resource addition decision unit determines whether it is necessary to add hardware resources to the system and what kind of hardware resources should be added, for each individual service;
the server addition unit causes the spare server to start offering one of the services that the resource addition decision unit has determined as being in need of an additional server; and
the storage addition unit enables access to the spare storage device from one of the services that the resource addition decision unit has determined as being in need of an additional storage device.

3. The system configuration management program according to claim 1, wherein:
the operating condition monitor observes storage capacity usage in the system; and
the resource addition decision unit determines whether it is necessary to add hardware resources to the system, and what kind of hardware resources should be added, according to the degree of increase in the storage capacity usage observed in the predetermined period, with reference to the resource addition policy dataset.

4. The system configuration management program according to claim 1, wherein:
the operating condition monitor observes the number of accesses to the system; and
the resource addition decision unit determines whether it is necessary to add hardware resources to the system, and what kind of hardware resources should be added, according to the degree of increase in the number of accesses observed in the predetermined period, with reference to the resource addition policy dataset.

5. The system configuration management program according to claim 4, wherein the resource addition decision unit activates the server addition unit and/or storage addition unit, if the observed increase in the number of accesses equals or exceeds an access count increase threshold that is defined in the resource addition policy dataset.

6. The system configuration management program according to claim 5, wherein the resource addition decision unit increases the access count increase threshold by a predetermined increment each time a new hardware resource is added to the system.

7. A system configuration management method for adding hardware resources to a system in operation, the method comprising the steps of:
(a) observing load of the system in operation;
(b) determining whether it is necessary to add hardware resources to the system, and what kind of hardware resources should be added, according to the degree of increase in the load observed in a predetermined period, with reference to a resource addition policy dataset that provides policy rules including whether to add a server or a storage unit;
(c) activating a spare server if it is determined at said step (b) that an additional server is required, the spare server having thus far been connected to the system as a spare resource in a standby state; and
(d) permitting the system to make access to a spare storage device if it is determined at said step (b) that an additional storage unit is required, the spare storage device having thus far been connected to the system as a spare resource that cannot be accessed from the system.

8. A system configuration management device for adding hardware resources to a system in operation, comprising:
an operating condition monitor that observes load of the system in operation;
a resource addition decision unit that determines whether it is necessary to add hardware resources to the system, and what kind of hardware resources should be added, according to the degree of increase in the load observed in a predetermined period, with reference to a resource addition policy dataset that provides policy rules including whether to add a server or a storage unit;
a server addition unit that activates a spare server if the resource addition decision unit determines that an additional server is required, the spare server having thus far been connected to the system as a spare resource in a standby state; and
a storage addition unit that permits the system to make access to a spare storage device if the resource addition decision unit determines that an additional storage unit is required, the spare storage device having thus far been connected to the system as a spare resource that cannot be accessed from the system.

9. A computer-readable storage medium storing a system configuration management program for adding hardware resources to a system in operation, the program causing a computer to function as:
an operating condition monitor that observes load of the system in operation;
a resource addition decision unit that determines whether it is necessary to add hardware resources to the system, and what kind of hardware resources should be added, according to the degree of increase in the load observed in a predetermined period, with reference to a resource addition policy dataset that provides policy rules including whether to add a server or a storage unit;
a server addition unit that activates a spare server if the resource addition decision unit determines that an additional server is required, the spare server having thus far been connected to the system as a spare resource in a standby state; and
a storage addition unit that permits the system to make access to a spare storage device if the resource addition decision unit determines that an additional storage unit is required, the spare storage device having thus far been connected to the system as a spare resource that cannot be accessed from the system.
